(19) United States
(12) Patent Application Publication
(10) Pub. No.: US 2007/0233855 A1
(43) Pub. Date: Oct. 4, 2007

(54) Adaptible keepalive for enterprise extenders

(75) Inventors: Patrick G. Brown, Hillsborough, NC (US); Randall T. Kunkel, Apex, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/396,532

(22) Filed: Apr. 3, 2006

(51) Int. Cl. G06F 15/173; G06F 15/16

(52) U.S. Cl. 709/224; 709/249

(57) ABSTRACT

Embodiments of the present invention address deficiencies of the art in respect to keep alive processing for enterprise extenders and provide a method, system and computer program product for adaptable keep alive processing for enterprise extenders. In one embodiment of the invention, an EE keep alive data processing system can be provided. The system can include an EE, a keep alive processor coupled to the EE, and a variable current timer value. The value can be configured for expansion in size responsive to the keep alive processor detecting a period of inactivity in an EE partner. The value further can be configured for contraction in size responsive to the keep alive processor detecting a period of activity in the EE partner.

### BACKGROUND OF THE INVENTION

1. Field of the Invention

The present invention relates to the field of enterprise extenders and more particularly to the keep alive function for enterprise extenders.

2. Description of the Related Art

The rapid growth of the Internet and the World Wide Web has driven most information technologists to add support for networking infrastructure and applications based upon the Transport Control Protocol/Internet Protocol (TCP/IP). Nonetheless, many continue to utilize applications, devices, and networking infrastructure based upon the well established Systems Network Architecture (SNA) or its follow-on, Advanced Peer-to-Peer Networking (APPN). In the latter circumstance, SNA has formed the basis of mission-critical systems and applications that have been developed, enhanced, and tested over a period of decades.

SNA is often the underlying architecture of the applications that are at the very heart of the information technology infrastructure. Organizations managing both SNA and IP applications and infrastructure have had two basic choices: maintain two separate networks, or migrate to a common IP backbone and integrate both environments. Although expensive to maintain two different networks, some organizations accept the cost in order to minimize the disruption to the mission-critical SNA applications. Other, more ambitious organizations choose to integrate.

Recent technologies permit organizations to straddle the fence between integration and maintaining two separate networks. Utilizing data link switching (DLSw), enterprises have been able to transport SNA data over IP networks. While DLSw is a well-established technology, Enterprise Extender (EE) technology represents a superior approach to SNA/IP integration. EE technology offers organizations the ability to keep existing SNA devices and applications, but support pure IP from end to end with no loss of availability or reliability. In this regard, EE facilitates the creation of a totally IP-based network, from host to host.

EE utilizes keep-alive flows in order to monitor its connections during periods of low network activity. In a keep-alive flow, a keep-alive interval is defined. During the keep-alive interval, coupled EE partners can be monitored to detect inbound packets. If inbound packets are detected during the interval, the process can end. In contrast, if no inbound packets are detected during the interval, keep-alive messages, often in the form of logical data link control (LDLC) test flows are transmitted to validate the connection with the EE partners. If a keep-alive response is received within a timer specified limit, a new keep-alive cycle can begin. However, if a keep-alive response is not received, after a specified number of retries the EE connection can be terminated.

Generally, keep-alive flows are necessary to verify the health of the IP network as well as the EE partner. Yet, analysis of installations having a large number of EE connections reveal that the repeated operation of the keep-alive function during periods of relatively low network activity consumes a substantial amount of computing resources—particularly CPU resources. Specifically, in addition to maintaining the keep-alive timer itself, the I/O cost of sending keep-alive messages and the processing of subsequent responses has a significant impact on CPU utilization when large numbers of EE connections are active.

### BRIEF SUMMARY OF THE INVENTION

Embodiments of the present invention address deficiencies of the art in respect to keep alive processing for enterprise extenders and provide a novel and non-obvious method, system and computer program product for adaptable keep alive processing for enterprise extenders. In one embodiment of the invention, an EE keep alive data processing system can be provided. The system can include an EE, a keep alive processor coupled to the EE, and a variable current timer value. The value can be configured for expansion in size responsive to the keep alive processor detecting a period of inactivity in an EE partner. The value further can be configured for contraction in size responsive to the keep alive processor detecting a period of activity in the EE partner.

In another embodiment of the invention, a keep alive processing method for an EE can be provided. The method can include monitoring an EE partner link with an EE partner for traffic from the EE partner for an interval specified by a current timer value. The size of the current timer value can be varied responsive to detecting periods of activity and inactivity in the EE partner link. As an example, the size of the current timer can be doubled in value up to a maximum pre-specified size responsive to detecting periods of inactivity in the EE partner link. Conversely, the size of the current timer value can be restored to an initial current timer value responsive to detecting periods of activity in the EE partner link. Thereafter, the EE partner link can be subjected to keep alive processing whenever traffic is not detected during the interval.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an integrated IP/SNA network configured for adaptable keep alive processing for enterprise extenders; and,

FIG. 2 is a flow chart illustrating a process for adaptable keep alive processing for enterprise extenders in a network as shown in FIG. 1.

### DETAILED DESCRIPTION OF THE INVENTION

Embodiments of the present invention provide a method, system and computer program product for adaptable keep alive processing for enterprise extenders. In accordance with an embodiment of the present invention, an enterprise extender can be configured for keep alive processing using a variable timer value for monitoring activity on the enterprise extender. Specifically, the variable timer value can expand and contract so as to avoid excessive keep alive processing during periods of network inactivity in consequence of which undue processing resources in the SNA network can be consumed. In periods of inactivity, in particular, the variable timer value can be doubled in size up to a pre-determined maximum value.

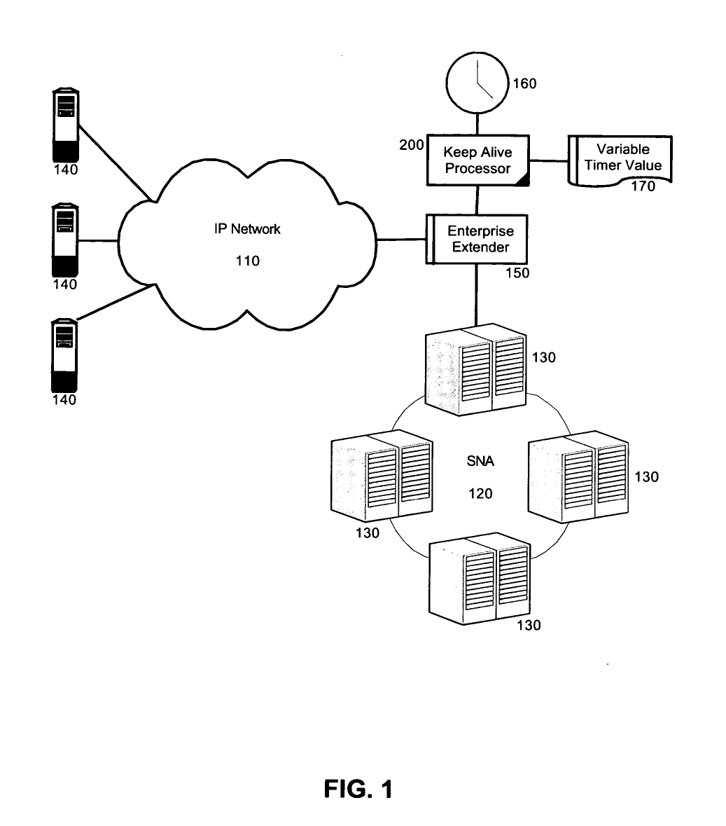

In further illustration, FIG. 1 is a schematic illustration of an integrated IP/SNA network configured for adaptable keep alive processing for enterprise extender. The integrated IP/SNA network can include an IP network 110 including one or more server computing devices 140 configured to interoperate according to TCP/IP. The integrated IP/SNA network further can include an SNA network 120 including one or more SNA type computing devices 130, such as mainframe or midrange computers configured to interoperate according to SNA.

The IP network 110 can be coupled to the SNA network 120 through an EE 150. The EE 150 can provide an integration bridge between the SNA network 120 and the IP network 110 so as to allow interoperability for the SNA type devices 130 with the server computing devices 140 in the IP network. As is known in the art, the EE 150 can include a keep alive processor 200 coupled to timer 160 to gauge whether or not to maintain an EE partner link with an EE partner managed by the EE 150. Unlike conventional EE technology, however, the keep alive processor 200 of the EE 150 can include a variable timer value 170 utilized to control when to transmit keep alive flows to EE partners managed by the EE 150.

For example, the keep alive processor 200 can monitor a high performance router (HPR) for the SNA network 120 to detect network layer packet (NLP) flow from EE partners managed by the EE 150 only for an interval specified by the variable timer value 170. Ordinarily, the interval will be fixed. In accordance with the present invention, however, the interval can vary depending upon periods of inactivity in the IP network 110. To provide for this variability, the variable timer value 170 can be doubled up to a specified maximum value whenever a period of inactivity is determined in the IP network 110 so as to avoid excessive transmission of keep alive flows. Conversely, in periods of normal activity in the IP network 110, the variable timer value 170 can be reset to a default value.

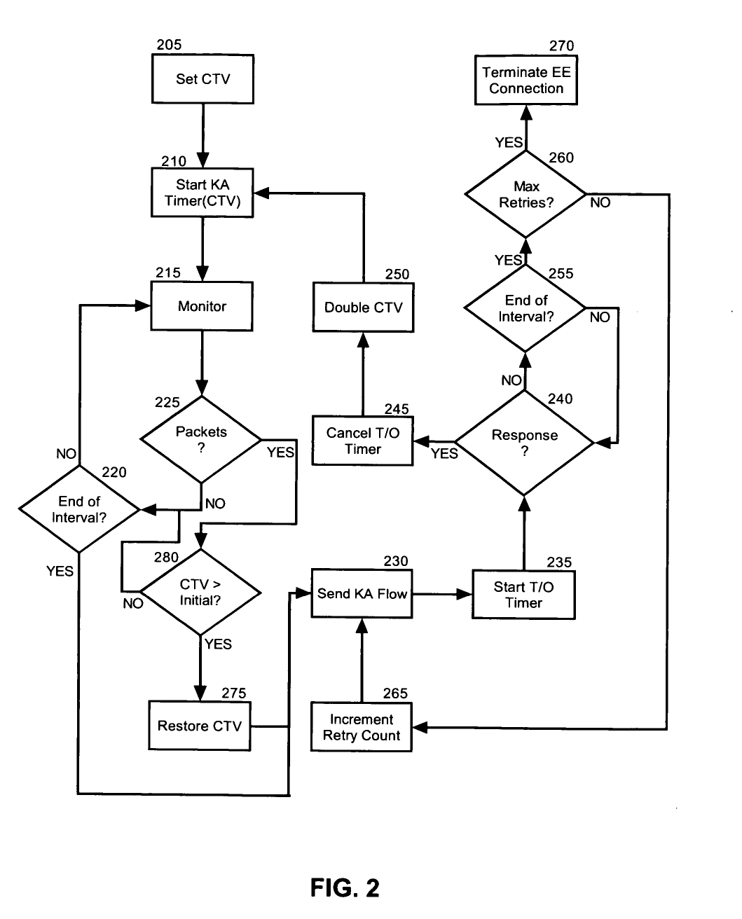

In further illustration, FIG. 2 is a flow chart illustrating a process for adaptable keep alive processing for enterprise extenders in a network as shown in FIG. 1. Notably, the process of FIG. 2 can be performed for each EE partner with an EE partner link with an enterprise extender. Beginning in block 205, a default value can be selected for a current timer value and the keep alive timer can be started for a duration specified by the current timer value in block 210. In block 215, inbound traffic can be monitored for one or more EE partner links to determine if packets were passed over the link indicating a period of activity. Packets that indicate a period of activity can include by way of example, a high performance router (HPR) data packet containing a data payload (so as to ignore HPR keep alive packets), an HPR packet containing pathswitch information, and an inbound exchange identifier (XID) from an EE partner meeting particular criteria.

Specifically, in the latter circumstance, an inbound XID from an EE partner can indicate that an EE partner has restarted a connection in certain circumstances. In particular, in this situation, it is possible that the EE partner has attempted to re-establish communication using the same IP address pair as a prior established EE partner link, but different service access point (SAP) pairs. Therefore, upon detection of an inbound XID utilizing the same IP address pairs, existing EE partner links can be located and processed for keep alive that are associated with the IP address pair, having a current timer value that exceeds the default value.

In any event, in decision block 225 it can be determined whether inbound packets have been received that indicate a period of activity with the specified EE partner over the partner link. If not, in decision block 220 it can be determined whether a monitoring interval has ended. If not, the monitoring process of block 215 can continue. Otherwise, a period of inactivity can be presumed with the specified EE partner over the partner link and a keep alive flow can be initiated in block 230. By comparison, in decision block 225, if it is determined that inbound packets have been received indicating a period of activity, in block 280 it can be determined whether the current timer value exceeds the initial value of the current timer value. If so, in block 275 the current timer value can be reset to a default value and in block 230 a keep alive flow can be initiated without waiting for the end of the monitoring interval.

In block 230, a keep alive flow, such as an LDLC test flow, can be transmitted over the partner link to test for responsiveness from the EE partner. In block 235, a time out timer can be initiated during which time a response is to be received from the EE partner. In decision block 240, if a response is not received, in decision block 255 if the time out interval has elapsed, in decision block 260, it can be determined whether a maximum number retries have been attempted. If not, in block 265 a retry count can be incremented and the process can repeat with the transmission of keep alive flow in block 230. In decision block 260, when a maximum number of retries have been attempted to no avail, in block 270 the EE partner link can be terminated.

Notably, in decision block 240, if a response is received during the time out interval from the EE partner in response to the keep alive flow, in block 245, the time out timer can be canceled and it can be determined that the EE partner is present, but engaged in a period of inactivity. Consequently, in block 250, the current timer value can be doubled in value limited to a pre-specified maximum value and the keep alive process can repeat for a larger interval of time due to the detection of a period of inactivity with the EE partner. In this way, unnecessary consumption of computing resources can be avoided during periods of inactivity, but once activity is detected, the current timer value can be reset to a default value.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An enterprise extender (EE) keep alive data processing system comprising:
an EE;
a keep alive processor coupled to the EE; and,
a variable current timer value configured for expansion in size responsive to the keep alive processor detecting a period of inactivity in an EE partner, and for contraction in size responsive to the keep alive processor detecting a period of activity in the EE partner.

2. The system of claim 1, wherein the EE is disposed between a systems network architecture (SNA) network and an Internet protocol (IP) network.

3. The system of claim 1, wherein the variable current timer value is configured to double in size up to a maximum pre-specified value responsive to the keep alive processor detecting a period of inactivity in an EE partner, and for contraction to a default size responsive to the keep alive processor detecting a period of activity in the EE partner

4. The system of claim 1, wherein the period of inactivity is represented by the detection of inbound packets from the EE partner.

5. The system of claim 1, wherein the inbound packets comprises high performance router (HPR) packets containing a payload.

6. The system of claim 1, wherein the inbound packets comprise high performance router (HPR) packets containing pathswitch information.

7. The system of claim 1, wherein the inbound packets comprises an inbound exchange identifier (XID) from an EE partner meeting criteria indicative of an EE partner attempting to restart a connection with the EE.

8. The system of claim 1, wherein the keep alive processor comprises program code enabled to transmit logical data link (LDLC) test flows to EE partners during a keep alive operation.

9. A keep alive processing method for an enterprise extender (EE), the method comprising:
monitoring an EE partner link with an EE partner for traffic from the EE partner for an interval specified by a current timer value;
varying a size of the current timer value responsive to detecting periods of activity and inactivity in the EE partner link; and,
keep alive processing the EE partner link whenever traffic is not detected during the interval.

10. The method of claim 9, wherein monitoring an EE partner link with an EE partner for traffic from the EE partner for an interval specified by a current timer value, comprises monitoring an EE partner link with an EE partner for one of high performance router (HPR) data packets containing a data payload, HPR data packets containing pathswitch information, and inbound exchange identifiers (XID)s from an EE partner meeting criteria indicative of an EE partner attempting to restart a connection with the EE.

11. The method of claim 9, wherein varying a size of the current timer value responsive to detecting periods of activity and inactivity in the EE partner link, comprises doubling the size of the current timer value up to a maximum pre-specified size responsive to detecting periods of inactivity in the EE partner link.

12. The method of claim 11, further comprising restoring the size of the current timer value to an initial current timer value responsive to detecting periods of activity in the EE partner link.

13. A computer program product comprising a computer usable medium embodying computer usable program code for keep alive processing for an enterprise extender (EE), the computer program product including:
computer usable program code for monitoring an EE partner link with an EE partner for traffic from the EE partner for an interval specified by a current timer value;
computer usable program code for varying a size of the current timer value responsive to detecting periods of activity and inactivity in the EE partner link; and,
computer usable program code for keep alive processing the EE partner link whenever traffic is not detected during the interval.

14. The computer program product of claim 13, wherein the computer usable program code for monitoring an EE partner link with an EE partner for traffic from the EE partner for an interval specified by a current timer value, comprises computer usable program code for monitoring an EE partner link with an EE partner for one of high performance router (HPR) data packets containing a data payload, HPR data packets containing pathswitch information, and inbound exchange identifiers (XID)s from an EE partner meeting criteria indicative of an EE partner attempting to restart a connection with the EE.

15. The computer program product of claim 13, wherein the computer usable program code for varying a size of the current timer value responsive to detecting periods of activity and inactivity in the EE partner link, comprises computer usable program code for doubling the size of the current timer value up to a maximum pre-specified size responsive to detecting periods of inactivity in the EE partner link.

16. The computer program product of claim 15, further comprising computer usable program code for restoring the size of the current timer value to an initial current timer value responsive to detecting periods of activity in the EE partner link.
